(19) United States
(12) Patent Application Publication
(10) Pub. No.: US 2018/0279586 A1
(43) Pub. Date: Oct. 4, 2018

(54) Method and Apparatus for Providing Seaweed Food in an Aquarium

(71) Applicant: Steven Yim, La Habra, CA (US)

(72) Inventor: Steven Yim, La Habra, CA (US)

(21) Appl. No.: 15/997,348

(22) Filed: Jun. 4, 2018

Related U.S. Application Data
(63) Continuation-in-part of application No. 15/008,234, filed on Jan. 27, 2016, now abandoned.
Application No. 15/008,234 is a continuation-in-part of application No. 62/111,086, filed on Feb. 2, 2015.

(51) Int. Cl. A01K 61/85

(52) U.S. Cl. CPC A01K 61/85

(57) ABSTRACT

A seaweed aquarium feeder and method allows fish to feed on seaweed food while preventing escape of the food into aquarium water. The feeder includes a base and hinged lid which closes against the base. The lid includes a rectangular recessed seaweed holding windowed area which fits over a protruding rectangular platform of the base. Seaweed food is cut or folded into rectangular sheets captured between the recessed seaweed holding windowed area of the lid and the protruding platform of the base. Windows in the lid allow the fish access to the seaweed food while covering edges of the folded or cut seaweed to prevent tearing off pieces of pieces of the seaweed which may clog an aquarium filter. A magnet pocket in the base holds a first magnet the feeder is held against an aquarium wall by cooperation of the first magnet with a second magnet outside the aquarium.

### CROSS-REFERENCE TO RELATED APPLICATIONS

The present application claims the priority of U.S. Provisional Patent Application Ser. No. 62/111,086 filed Feb. 2, 2015, and U.S. patent application Ser. No. 15/008,234 filed Jan. 27, 2016, which applications are incorporated in their entirety herein by reference.

### BACKGROUND OF THE INVENTION

The present invention relates to aquarium feeders and in particular to a seaweed food aquarium feeder.

A preferred aquarium food for some varieties of fish is seaweed. Many fresh and marine fish are herbivores and require constant algae grazing in order to stay healthy and thrive in aquariums. Many of these fish can be large that grow up to 12″ in length have voracious eating habits. These fish require a constant supply of seaweed opposed to quick feedings daily.

Nori seaweed is a preferred seaweed aquarium food but presents many problems in the feeding application. The Nori seaweed is processed into thin, typical 4 inch by 3.5 inch sheets which are very easy to tear. The Nori seaweed is generally inserted into a clip with a suction cup or magnet to stay in a stationary spot for the fish to feed. Unfortunately, the clips provide only one point of contact and are generally unable to hold the Nori seaweed tightly enough to prevent fish from tearing the Nori seaweed near the base of the clip. Further, constant water contact and currents also tends to rip and tear the Nori seaweed apart. The small pieces of the Nori seaweed then circulate through the aquarium until they are drawn into a filter intake clogging the filter.

U.S. Pat. No. 5,954,012 discloses a feeding device for aquariums. The device of the '012 patent includes mesh walls containing food. The mesh walls lack structure to clamp or hold the food, and fish may tear away portions of the food.

U.S. Pat. No. 5,778,825 discloses a frozen food feeder in FIG. 3 having holes 46 are large enough to allow fish to tug at portions of the frozen food therein and to allow the frozen food to pass therethrough as it thaws. FIG. 4 shows an aquarium feeder having holes 64 sized to allow fish to pull worms therethrough. The '825 patent does not disclose an aquarium feeder suitable to seaweed fish food and either feeder provides an aquarium feeder shaped to receive seaweed fish food which is cut or folded into rectangular sheets.

### BRIEF SUMMARY OF THE INVENTION

The present invention addresses the above and other needs by providing a seaweed aquarium feeder and method which allows fish to feed on seaweed food while preventing escape of the food into the aquarium water. The feeder includes a base and hinged lid which closes against the base. The lid includes a rectangular recessed seaweed holding windowed area which fits over a protruding rectangular platform of the base. Seaweed food is cut or folded into rectangular sheets captured between the recessed seaweed holding windowed area of the lid and the protruding platform of the base. Windows in the lid allow the fish access to the seaweed food while covering edges of the folded or cut seaweed to prevent tearing off pieces of pieces of the seaweed which may clog an aquarium filter. A magnet pocket in the base holds a first magnet and the feeder is held against an aquarium wall by cooperation of the first magnet with a second magnet outside the aquarium.

In accordance with one aspect of the invention, there is provided a method for providing seaweed food to aquarium fish. The seaweed food is cut or folded into rectangular seaweed sheets. The rectangular sheet is positioned over a platform projecting out from a base of an aquarium seaweed feeder. A windowed lid is placed over the platform, the edges of the rectangular seaweed sheets not exposed through any of the windows. Positioning the aquarium seaweed feeder in an aquarium below aquarium water line.

In accordance with yet another aspect of the invention, there is provided a seaweed feeder. The seaweed feeder solves common seaweed feeding issues holding a cut or folded sheet of seaweed. The seaweed feeder includes a base having a protruding platform having a solid back. A lid includes a matching area that fits over the protruding platform to sandwich the seaweed, and windows in the lid allow aquarium fish limited access to the seaweed for slow grazing. The entire seaweed portion is contained in the feeder preventing large pieces of the seaweed sheet from being torn by the fish or currents in the water, and promotes all day feeding.

In accordance with another aspect of the invention, there is provided a seaweed feeder including a lid having small windows limiting exposure of seaweed sheets. The windows are preferably between 6 mm and 14 mm long and between 6 mm and 16 mm wide and the lid acts as a clamp sandwiching the seaweed sheet between the lid and solid base preventing or limiting the seaweed sheet from being ripped and pulled apart by large fish.

In accordance with still another aspect of the invention, there is provided a seaweed feeder magnetically held in the aquarium. A magnet resides in a magnet recess in the base, and an aquarium wall is sandwiched between the magnet and a cooperating external magnet to hold the seaweed feeder in a vertical or horizontal position, or anywhere between vertical and horizontal.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows an aquarium with three improved aquarium feeders according to the present invention.

FIG. 2A shows a top perspective view of a seaweed feeder according to the present invention.

FIG. 2B shows a bottom perspective view of the seaweed feeder according to the present invention.

FIG. 3 shows a top view of the seaweed feeder according to the present invention.

FIG. 4A shows a cross-sectional view of the seaweed feeder according to the present invention taken along line 20-20 of FIG. 3.

FIG. 4B shows a cross-sectional view of the seaweed feeder according to the present invention with a closed cover.

FIG. 5 shows the seaweed feeder according to the present invention capturing a sheet of seaweed.

FIG. 6 shows a top view of the seaweed feeder according to the present invention containing a sheet of seaweed.

FIG. 7 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement. The term “horizontal” refers to the plane the feeder primarily resides in against an aquarium wall and the term “vertical” refers to dimensions generally perpendicular to the horizontal. A substantially rectangular closed perimeter refers to a rectangular wall which may include rounded corners. The feeder is preferably made from plastic or a similar material, and surfaces are not precisely horizontal or vertical, given manufacturing tolerances, but generally appear to be horizontal and vertical within the above definition.

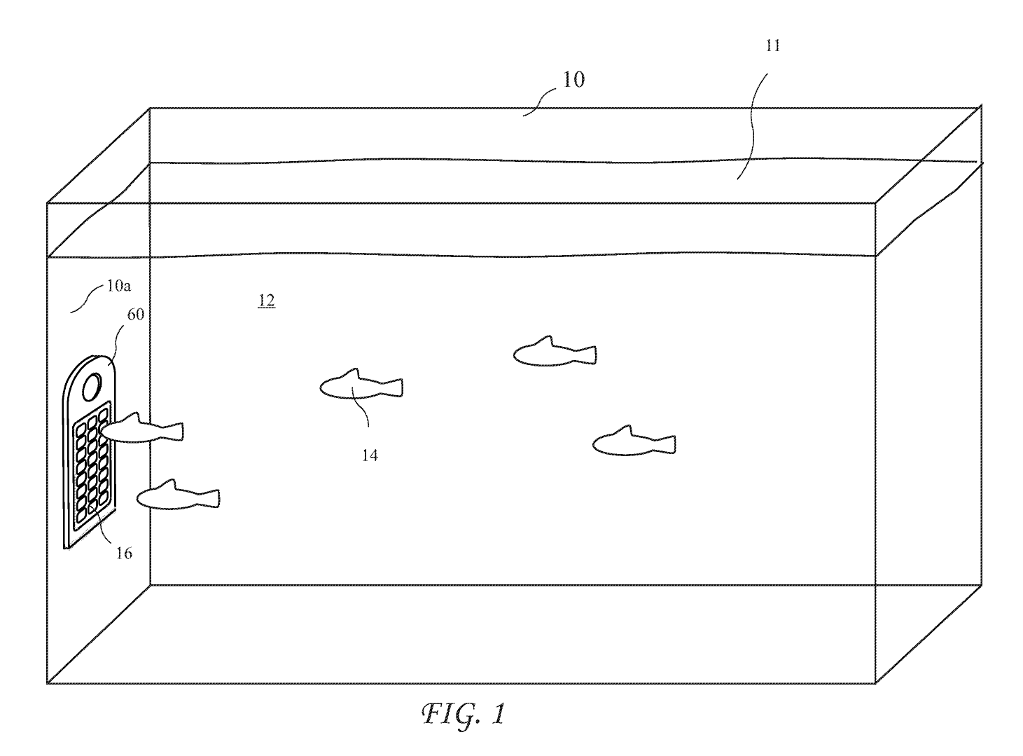

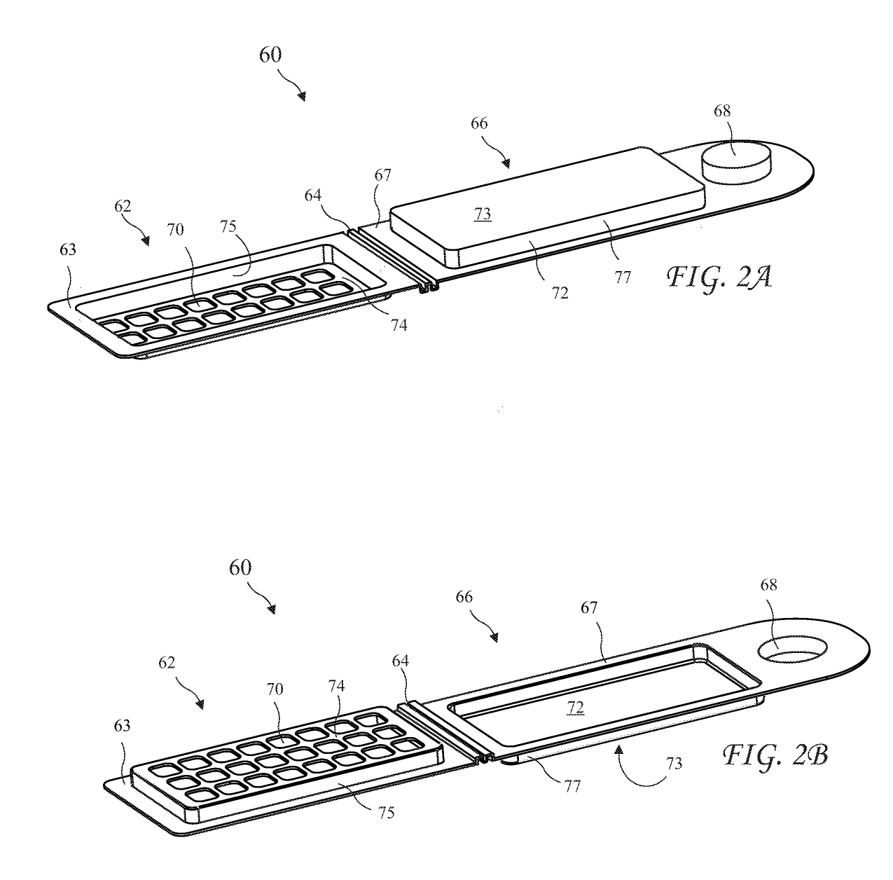

An aquarium 10 with an improved aquarium feeder 60 according to the present invention is shown in FIG. 1. The seaweed feeder 60 is held against an aquarium wall 10a below an aquarium water line 11, and holds seaweed (see FIG. 5) 16 accessible to fish 14 through windows 10 (see FIG. 2A).

A top perspective view of a seaweed feeder 60 is shown in FIG. 2A and a bottom perspective view of a seaweed feeder 60 is shown in FIG. 2B. The seaweed feeder 60 includes a base 66 having a generally horizontal and flat base flange 67 surrounding a generally rectangular (may have rounded edges and corners) protruding platform 72 extending generally perpendicularly out of the base flange 67, and a magnet pocket 68. The protruding platform 72 preferably has a solid face 73 (i.e., no openings) residing parallel to the base flange 67. A base wall 77 connects the solid face 73 to the base flange 67. The base wall 77 is generally perpendicular to the solid face 73 and to the base flange 67.

A lid 62 is connected to the base 66 by a hinge 64. The lid 62 includes a generally flat and horizontal lid flange 63 surrounding a generally rectangular recessed windowed area 74 receding from the lid flange 63 and residing in a plane generally parallel with the lid flange 63. The windowed area 74 includes a multiplicity of windows 70, for example, between 12 and 40 windows 70 in between six and ten rows and two and four columns and preferably 24 windows 70 in eight rows and three columns. A lid wall 75 is generally perpendicular to both the lid flange 63 and the windowed area 74 and connects the recessed windowed area 74 to the lid flange 63. The lid wall 75 is generally parallel to the base wall 77 when the lid 62 is closed over the base 66 the lid wall 75 and base wall 77 provide an interference fit to retain the lid 62 on the base 66.

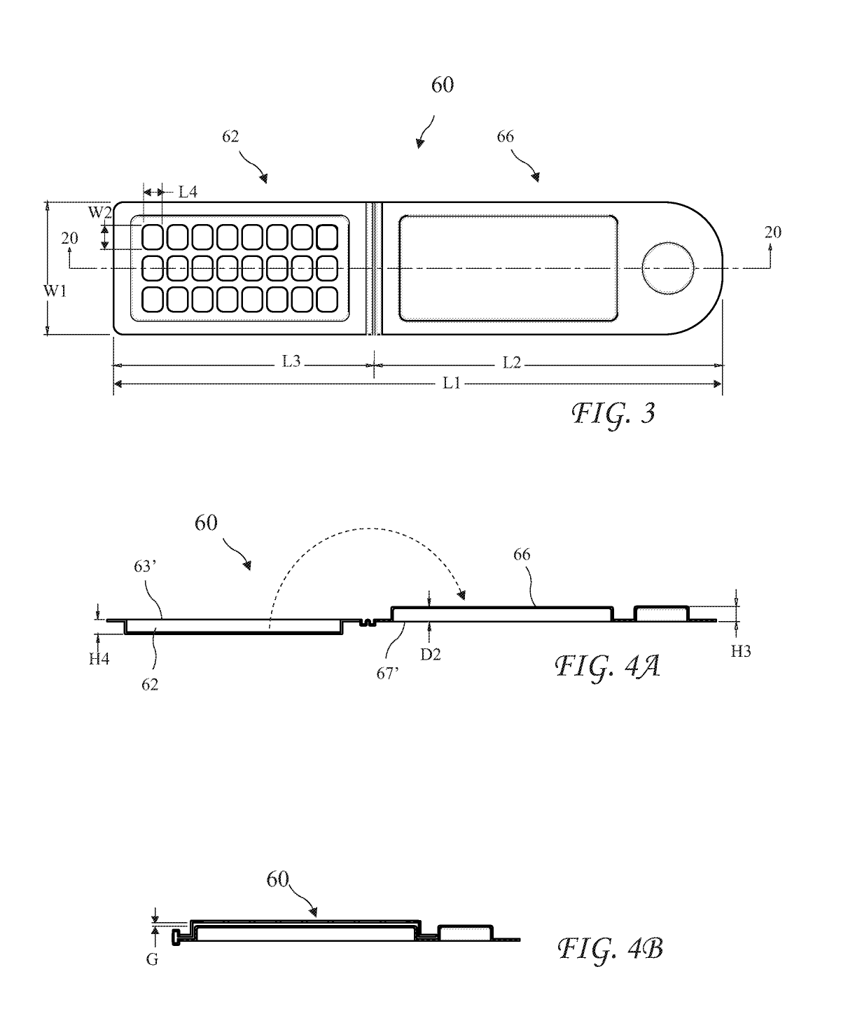

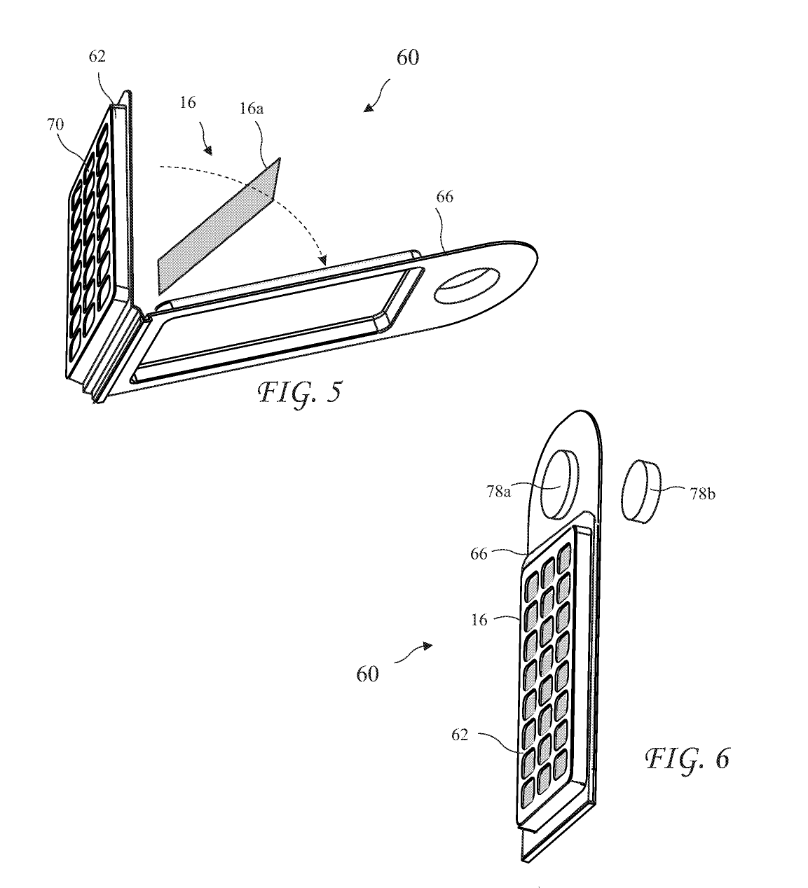

A top view of the seaweed feeder 60 is shown in FIG. 3, a cross-sectional view of the seaweed feeder 60 taken along line 20-20 of FIG. 3 is shown in FIG. 4A, and a cross-sectional view of the seaweed feeder 60 with a closed cover is shown in FIG. 4B. The seaweed feeder 60 has an overall length L1 of preferably 313 mm. The base 66 has a length L2 of preferably about 179 mm, and the lid 62 has a length L3 of preferably about 134 mm. The base 66 and lid 62 preferably have a width W1 of preferably about 68 mm. The base 66 has a height H3 of preferably between 7 mm and 10 mm and more preferably about 7.8 mm and the lid 62 has a height H4 of preferably between 7 mm and 10 mm and more preferably about 7.5 mm. The windows have a length L4 of preferably between 6 mm and 14 mm and more preferably about 10 mm, and a width W2 of preferably between 6 mm and 16 mm and more preferably about 12 mm. When the lid 62 is closed, a gap G is created between the recessed windowed area 74 and the protruding platform 72 for the seaweed food 16. The gap G may vary and conforms to the thickness of the seaweed sheet 16 (see FIG. 5).

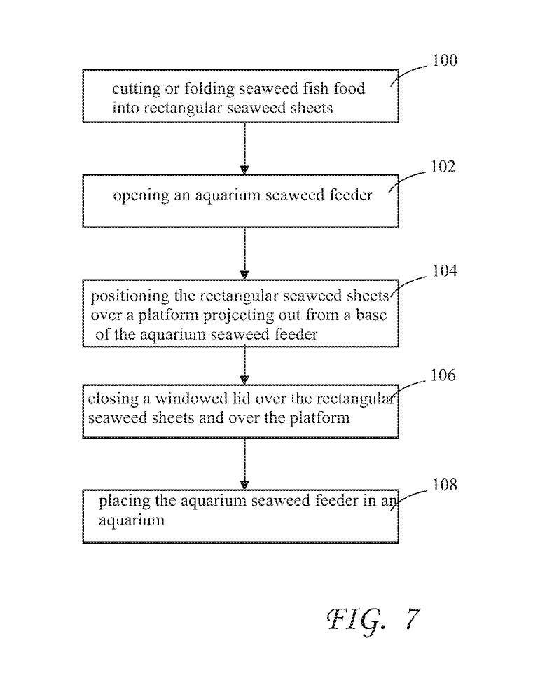

The seaweed feeder 60 is shown capturing a substantially rectangular sheet of seaweed 16 between the base 66 and lid 62 in FIG. 5 and a top view of the seaweed feeder 60 is shown closed and containing the sheet of seaweed 16 in FIG. 6. The sheet of seaweed 16 is not necessarily perfectly rectangular but is sufficiently rectangular and edges 16a sufficiently straight, so that none of the edges 16a of the seaweed 16 are exposed through the windows 70 of the lid 61. A magnet 78a resides in the magnet pocket 68 (see FIG. 2), and the seaweed feeder 60 may be held to the aquarium 10 wall (see FIG. 10) by a cooperating magnet 78b the exterior of the aquarium.

A method according to the present invention is described in FIG. 7. The seaweed food is cut or folded into substantially rectangular seaweed sheets at step 100. The aquarium seaweed feeder is opened at step 102. The rectangular seaweed sheets are positioned over a platform projecting out from a base of the aquarium seaweed feeder at step 104. A windowed lid is closed over the rectangular seaweed sheets and over the platform at step 106. The aquarium seaweed feeder is positioned below an aquarium water line in an aquarium at step 108.

The seaweed feeder 60 is preferably made from plastic, and more preferably from Polyvinyl Chloride (PVC) or Acrylonitrile Butadiene Styrene (ABS) and most preferably from ABS.

While the invention herein disclosed has been described by means of specific embodiments and applications thereof, numerous modifications and variations could be made thereto by those skilled in the art without departing from the scope of the invention set forth in the claims.

I claim:

1. A method for feeding seaweed to aquarium fish, comprising:
preparing a substantially rectangular seaweed sheet;
opening an aquarium seaweed feeder;
positioning the rectangular seaweed sheet over a platform projecting out from a base of the aquarium seaweed feeder;
closing a windowed lid over the rectangular seaweed sheets and over the platform; and
placing the aquarium seaweed feeder in an aquarium.

2. The method of claim 1, wherein preparing a substantially rectangular seaweed sheet comprises folding seaweed to prepare the substantially rectangular seaweed sheet.

3. The method of claim 1, wherein preparing a substantially rectangular seaweed sheet comprises cutting seaweed into the substantially rectangular seaweed sheet.

4. The method of claim 1, wherein:
preparing a substantially rectangular seaweed sheet comprises cutting or folding seaweed into the substantially rectangular seaweed sheet sufficiently rectangular and having edges sufficiently straight, so that no edge of the seaweed is exposed through windows in the windowed lid; and
closing a windowed lid over the rectangular seaweed sheets and over the platform comprises closing a windowed lid over the rectangular seaweed sheets and over the platform so that no edge of the seaweed is exposed through windows in the windowed lid when the windowed lid is closed over the platform.

5. The method of claim 1, wherein opening the aquarium seaweed feeder comprises opening the aquarium seaweed feeder comprising:
a base including a generally rectangular protruding platform;
the windowed lid includes a recessed seaweed holding windowed area having a profile providing an interference fit to the rectangular protruding platform of the base, the windowed area including a multiplicity of windows therethrough; and
the windowed lid rotatable to position the recessed seaweed holding windowed area of the windowed lid over the rectangular protruding platform of the base creating a gap to contain the substantially rectangular seaweed sheet.

6. The method of claim 5, wherein:
the base further includes a flat horizontal base flange;
the generally rectangular protruding platform includes a flat face residing parallel with the base flange;
a base wall forms a substantially rectangular closed perimeter reaching from the base flange perpendicular to the base flange and connects the flat face to the base flange;
the windowed lid includes a flat lid flange;
recessed seaweed holding windowed area includes a flat windowed area including the windows; and
a lid wall forms a second closed generally rectangular perimeter reaching from the lid flange to the flat windowed area.

7. The method of claim 6, wherein the lid flange rests in direct contact against the base flange when the windowed lid is closed onto the base.

8. The method of claim 6, wherein the flat face is a solid flat face.

9. The method of claim 6, wherein the windowed lid hingedly attached to the base.

10. The method of claim 6, wherein:
the lid wall resides in intimate contact parallel with the base wall when the windowed lid is closed over the base; and
static friction between the lid wall and the base wall provide an interference fit to retain the windows lid on the base.

11. The seaweed feeder of claim 6, wherein the windows have a length L4 between 6 mm and 14 mm and a width W2 between 6 mm and 16 mm.

12. The seaweed feeder of claim 11, wherein the length L4 is about 10 mm and the width W2 is about 12 mm.

13. The seaweed feeder of claim 12, wherein the multiplicity of windows comprises six and ten rows and between two and four columns of the windows.

14. The seaweed feeder of claim 13, wherein the multiplicity of windows comprises eight rows and three columns of the windows.

15. The seaweed feeder of claim 6, wherein the base further includes a magnet pocket containing a first magnet, and a second magnet cooperates with the first magnet to sandwich an aquarium wall to hold the seaweed feeder in place in an aquarium.

16. The seaweed feeder of claim 6, wherein the seaweed feeder is made from Acrylonitrile Butadiene Styrene (ABS).

17. A method for feeding seaweed to aquarium fish, comprising:
cutting or folding seaweed into a substantially rectangular seaweed sheet having substantially straight edges;
opening an aquarium seaweed feeder comprising:
a base including a flat horizontal base flange;
a generally rectangular protruding platform including a flat face residing parallel with the base flange;
a base wall forming a substantially rectangular closed perimeter reaching from the base flange perpendicular to the base flange and connects the flat face to the base flange;
a windowed lid hingedly attached to the base and including a flat lid flange;
a recessed seaweed holding windowed area including a flat windowed area parallel with the flat lid flange including windows; and
a lid wall forming a second closed generally rectangular perimeter reaching from the lid flange to the flat windowed area; and
the windowed lid rotatable to position the recessed seaweed holding windowed area of the windowed lid over the rectangular protruding platform of the base creating a gap to contain the substantially rectangular seaweed sheet.
positioning the rectangular seaweed sheet over a platform projecting out from a base of the aquarium seaweed feeder;
closing a windowed lid over the rectangular seaweed sheets and over the platform so that no edge of the seaweed is exposed through the windows in the windowed lid when the windowed lid is closed over the platform;
the lid wall residing in intimate contact parallel with the base wall when the windowed lid is closed over the base;
retaining the windows lid on the base by static friction between the lid wall and the base wall provide an interference fit; and
placing the aquarium seaweed feeder in an aquarium.

18. A method for feeding seaweed to aquarium fish, comprising:
cutting or folding seaweed into a substantially rectangular seaweed sheet having substantially straight edges;
opening an aquarium seaweed feeder comprising:
a base including a flat horizontal base flange;
a generally rectangular protruding platform including a flat face residing parallel with the base flange;
a base wall forming a substantially rectangular closed perimeter reaching from the base flange perpendicular to the base flange and connects the flat face to the base flange;
a windowed lid hingedly attached to the base and including a flat lid flange;
a recessed seaweed holding windowed area including a flat windowed area parallel with the flat lid flange including a multiplicity of windows, the multiplicity of windows comprising:
eight rows and three columns of the windows; and
a length L4 is about 10 mm and a width W2 of about 12 mm;
a lid wall forming a second closed generally rectangular perimeter reaching from the lid flange to the flat windowed area; and
the windowed lid rotatable to position the recessed seaweed holding windowed area of the windowed lid over the rectangular protruding platform of the base creating a gap to contain the substantially rectangular seaweed sheet.
positioning the rectangular seaweed sheet over a platform projecting out from a base of the aquarium seaweed feeder;
closing a windowed lid over the rectangular seaweed sheets and over the platform so that no edge of the seaweed is exposed through the windows in the windowed lid when the windowed lid is closed over the platform;
the lid wall residing in intimate contact parallel with the base wall when the windowed lid is closed over the base;
retaining the windows lid on the base by static friction between the lid wall and the base wall provide an interference fit; and
placing the aquarium seaweed feeder in an aquarium.
